(19) United States
(12) Patent Application Publication
(10) Pub. No.: US 2003/0102721 A1
(43) Pub. Date: Jun. 5, 2003

(54) Moving coil type planar motor control

(76) Inventors: Toshio Ueta, Redwood City, CA (US); Bausan Yuan, San Jose, CA (US)

Correspondence Address: PENNIE & EDMONDS LLP, 1667 K STREET NW, SUITE 1000, WASHINGTON, DC, 20006

(21) Appl. No.: 10/000,369

(22) Filed: Dec. 4, 2001

(51) Int. Cl. H02K 41/00

(52) U.S. Cl. 310/12

(57) ABSTRACT

A control system for a moving coil type planar motor is disclosed that operates with a commutation circuit requiring a decreased number of amplifiers as compared to moving magnet type planar motors. The control system permits positioning with three degrees of freedom. Motor force and torque ripple during translational forces and yaw torque is minimized by the control system.

### FIELD OF THE INVENTION

The invention relates to planar motors. More particularly, the invention is related to a control system for a moving coil type planar motor.

### BACKGROUND OF THE INVENTION

Precision systems, such as those used in semiconductor processing, inspection and testing, often use linear motors for positioning objects such as semiconductor wafers. Conventional precision systems include separate, stacked stages that permit movement along perpendicular axes (i.e., an “X” stage stacked on a “Y” stage). These systems typically are complex, heavy and inefficient in operation. Improved object positioning, particularly for use in lithographic instruments, has been realized through the use of planar motors, which advantageously permit simplicity in design, weight savings, as well as enhanced precision and efficiency. Such a linear or planar motor, in principle, operates in accordance with the Lorentz law, which relates the force on a charged particle to its motion in an electromagnetic field. An object such as a stage in a lithography system may be translated or propelled using the electromagnetic force generated by a wire or coil carrying an electric current in a magnetic field. The planar motor provides a single stage to replace conventional stacked stages, with the stage being electromagnetically suspended or levitated for enhanced performance and versatility.

Planar motors typically include a magnet array and a coil array. Several basic designs for planar motors are known, and are distinguished based on which of the components are positionally fixed and which move with respect thereto. In a first design, commonly referred to as a “moving coil type” planar motor, the coil array moves with respect to a positionally fixed magnet array. In one embodiment, as disclosed in U.S. Pat. No. 6,097,114 to Hazelton and shown schematically in FIG. 1, a moving coil planar motor 100 includes a base 102 with a flat magnet array 103 having a plurality of magnets 104. A single X coil 106 and two Y Coils 108, 110 are attached to the underside of a stage frame 112 (drawn in dashed lines) suspended above and parallel to magnet array 102. Y coils 108, 110 are similar in structure to one another and have coil wires oriented to provide force substantially in a Y direction. X coil 106 and Y coils 108, 110 are similar in structure, but X coil 106 has coil wires oriented to provide force substantially in an X direction perpendicular to the Y direction.

X coil 106 and Y coils 108, 110 permit movement of stage frame 112. To provide force to stage frame 112 in the X direction relative to magnet array 102, two phase, three phase, or multiphase commutated electric current is supplied to X coil 106 in a conventional manner by a commutation circuit and current source 114. To provide force to stage frame 112 in the Y direction, two phase, three phase, or multiphase commutated electric current is supplied to either one or both of the Y coils 108, 110 in a conventional manner by respective commutation circuits and current sources 116 and/or 118. To provide rotational torque to frame 112 relative to magnet array 102 in a horizontal plane parallel to the X and Y axes, commutated electric current is supplied to either of Y coils 108, 110 individually by respective commutation circuits and current source 116 or 118. Alternatively, electric current is supplied to both Y coils 108, 110 simultaneously but with opposite polarities by respective commutation circuits and current sources 116, 118, providing Y force to one of Y coils 108, 110 in one direction and the other Y coil 108, 110 in an opposite direction, thereby generating a torque about an axis normal to the XY plane. This torque typically causes rotation of stage frame 112 in the XY plane.

In a second design, also disclosed in U.S. Pat. No. 6,097,114 to Hazelton and shown schematically in FIG. 2, a “moving magnet type” planar motor includes a magnet array that moves with respect to a positionally fixed coil array. In one embodiment, moving magnet planar motor 200 includes an upper surface of a flat base 202 that is covered with coil units 204. A positioning stage 206 is suspended above flat base 202 and has an array of magnets 208 facing the upper surface of flat base 202. A conventional commutation circuit (not shown) controls and supplies electric current to coil units 204 in accordance with the desired direction of travel of positioning stage 206. Appropriately commutated electric current creates Lorentz forces, which propel positioning stage 206 to a desired location, altitude, and attitude.

Suspension of a stage 112, 206 may be accomplished using a variety of techniques. For example, additional, permanent magnets may be provided on the upper surface of a stage 112, 206 and on a stationary frame located above the stage 112, 206 (not shown). Alternatively, an air bearing may be provided between a stage 112, 206 and its respective base 102, 202. Electromagnetic force generated by the motor may instead provide the necessary suspension force.

As described above, two phase, three phase, or multiphase commutated electric current may be supplied to the coils through a commutation circuit. To this end, a drawback inherent to moving magnet type planar motors is that each phase for each coil unit is driven by a separate amplifier of a commutation circuit. Experimentally, it has been found that the required number of amplifiers is a function of the stage size; if the stage size is increased, the number of amplifiers necessary for the commutation circuit proportionally increases. For example, to drive a 5×5 moving magnet array, a suitable commutation current is generated in accordance with a four-phase motor commutation equation. In such a motor, there is a phase difference of π/2 radians between each phase, and as a result, each coil must be driven by a separate amplifier. Consequently, the array of 25 coils requires 25 amplifiers. Thus, there is a need for a planar motor control with a decreased number of amplifiers as compared to the requirements of moving magnet type planar motors.

In some magnet arrays, half magnets and/or quarter magnets are provided along the perimeter of the array to optimize the efficiency with respect to providing magnetic flux. Without the perimeter of half and/or quarter magnets, the perimeter may consist of sides of magnet segments with one pole (north or south) having no coupled nearest neighbor magnet segments of the other pole, and therefore the array may not efficiently provide magnetic flux. In addition, magnets may be provided in various shapes and sizes. Typically, magnet edge effect treatment is required, and thus there is a need for a planar motor control that obviates the need for significant magnet edge effect treatment.

In order to achieve smooth operation of planar motors, rigorous computational power must be provided. For example, complex mathematical relationships must be evaluated to achieve the desired torque and translation in the X and Y directions. To this end, significant CPU power typically is required. A need exists, therefore, for planar motor control using relationships with less complexity. In addition, certain commutation produces a motor force ripple, and thus, there further exists a need for a planar motor control with minimized force ripple.

Also, there is a need for a planar motor control that does not require a switch function in order to achieve a desired torque at any given stage location.

### SUMMARY OF THE INVENTION

The present invention is related to a planar motor including a magnet array having a plurality of magnets, a coil array having a plurality of coils, and a control system configured to selectively provide electric current to the coil array for translational movement in two degrees of freedom and rotation in a third degree of freedom. The current is controlled to at least substantially reduce torque ripple in the movement. In a preferred embodiment, a coil array according to the invention is square and includes sixteen coils, and the commutation circuit comprises one amplifier for each coil. The magnet array is preferably disposed about a magnet plane and the translational movement occurs in directions substantially parallel to the magnet plane with the directions being substantially orthogonal to one another. The directions maybe the x-direction and y-direction, with a plurality of coils disposed parallel to the x-direction defining a row and a plurality of coils disposed parallel to the y-direction defining a column. The coils in each row and each column may produce a torque that follows the relationship ¹²Iₜkₐ, wherein Iₜ is the current and kₐ is the magnetic force constant of a coil. The current supplied to the coil array for translational movement may follow the relationship

$$\frac{{F}_{n}}{4 {k}_{a}} ,$$

wherein Fₙ is the component of force in the x-direction or the y-direction. In addition, the current supplied to the coil array for torque may follow the relationship

$$\frac{{Torque}_{n}}{12 {k}_{a}} ,$$

wherein Torqueₙ is the component of torque from one or more coils in a x-direction or a y-direction. The control system compensates for undesired torque, which may be a sinusoidal function that is compensated by a negative of the sinusoidal function. Current applied to the coil array produces a force for the translational movement that is a function of the product of the current and a force constant, and produces a torque that is a function of the product of the current and a force constant.

A preferred embodiment of the present invention also is related to lithographic instruments, including a positioning stage, a planar magnet array, a planar coil array coupled to the positioning stage, and a control system configured to selectively provide electric current to the coil array for translational movement in two degrees of freedom and rotation in a third degree of freedom, with the current being controlled to at least substantially reduce force and torque ripple in the movement.

The present invention further is related to a method for controlling a planar motor for positioning in three degrees of freedom. The method includes: positioning a movable coil array over a fixed magnet array, the coil array having coils generally disposed in a plane defining first and second directions that are substantially orthogonal to one another, and the magnet array having magnets with magnetic fields; determining currents to be applied to coils to generate substantially ripple free translational forces between the coil array and the magnet array in the first and second directions and substantially ripple free torque about a third direction perpendicular to the plane; and applying currents as determined to the coils to move the coils. The determining currents may include determining compensating currents required to compensate for undesired torque, and the undesired torque may be a sinusoidal function with the compensating currents being the negative of the sinusoidal function. The undesired torque may follow the relationship −12kₐIₓ sin(πpt_{y}), wherein Iₓ is the current and pt_{y} is the pitch.

An embodiment of the present invention also relates to a system for controlling a planar motor, the motor including an array of coils for producing translational forces in two degrees of freedom. The system includes a controller, a sensor for sensing position of the coils, a first comparator for receiving position feedback from the sensor, and a second comparator for receiving input from a position disturbance in a third degree of freedom. The controller at least substantially applies a compensation function to the position disturbance and provides a corrected output position. The controller may include at least two amplifiers.

In addition, the present invention relates to a planar motor comprising magnet array means, coil array means, and control means providing electric current to said coil array means for controlled movement in three degrees of freedom including means for at least substantially eliminating ripple.

Furthermore, the present invention is related to a stage system including a planar motor, the planar motor including a magnet array having a plurality of magnets, a coil array having a plurality of coils, and a control system configured to selectively provide electric current to the coil array for translational movement in two degrees of freedom and rotation in a third degree of freedom, with the current being controlled to at least substantially reduce force and torque ripple in the movement.

The present invention also is related to an exposure apparatus including an illumination system that supplies radiant energy. The exposure apparatus also has a stage system including a planar motor, the planar motor including a magnet array having a plurality of magnets, a coil array having a plurality of coils, and a control system configured to selectively provide electric current to the coil array for translational movement in two degrees of freedom and rotation in a third degree of freedom, with the current being controlled to at least substantially reduce force and torque ripple in the movement. The stage system carries at least one object disposed on a path of the radiant energy. A device can be manufactured with the exposure apparatus. Any of a variety of devices such as semiconductor chips (e.g., integrated circuits or large-scale integrations), liquid crystal panels, CCDs, thin film magnetic heads, or micro-machines, can be manufactured with the exposure apparatus.

The present invention additionally is related to a wafer including an image, wherein the image is formed with an exposure apparatus that includes: an illumination system that supplies radiant energy; and a stage system including a planar motor, the planar motor including a magnet array having a plurality of magnets, a coil array having a plurality of coils, and a control system configured to selectively provide electric current to the coil array for translational movement in two degrees of freedom and rotation in a third degree of freedom, the current being controlled to at least substantially reduce force and torque ripple in the movement. The stage system carries at least one object disposed on a path of the radiant energy.

### BRIEF DESCRIPTION OF THE DRAWINGS

Preferred features of the present invention are disclosed in the accompanying drawings, wherein similar reference characters denote similar elements throughout the several views, and wherein:

FIG. 1 is a perspective view schematically showing a prior art moving coil planar motor;

FIG. 2 is a perspective view schematically showing a prior art moving magnet planar motor;

FIG. 3 is a top view schematically showing a square moving coil planar motor according to an embodiment of the present invention disposed at an initial position with respect to the magnet array;

FIG. 4 is a perspective view of the square coil array of FIG. 3;

FIG. 5 is a top view of the square coil array of FIG. 3;

FIG. 5A is a top view schematically showing a four phase moving coil planar motor according to an embodiment of the present invention;

FIG. 5B is another top view of the four phase moving coil planar motor of FIG. 5A;

FIG. 6 is a partial top view of the square coil array of FIG. 3 with one row of coils disposed at an initial position with respect to the magnet array;

FIG. 7 is a partial top view of the square coil array of FIG. 3 with one row of coils disposed at another position with respect to the magnet array;

FIG. 8 is a top view schematically showing a square moving coil planar motor disposed at another position with respect to the magnet array;

FIG. 9 is an exemplar graph showing undesired torque behavior;

FIG. 10 is an exemplar graph showing desired translation force after torque compensation according to the present invention;

FIG. 11 is an exemplar graph showing desired yaw torque after torque compensation according to the present invention;

FIG. 12A is a block diagram showing the use of an amplifier for each coil of the present invention;

FIG. 12B is a block diagram of a position control system for a coil of the present invention;

FIG. 13 is an elevational view, partially in section, showing a lithographic apparatus incorporating a planar motor-driven positioning stage according to the present invention;

FIG. 14 is a flowchart showing the fabrication of semiconductor devices; and

FIG. 15 is a flowchart showing details of the wafer processing step of FIG. 14.

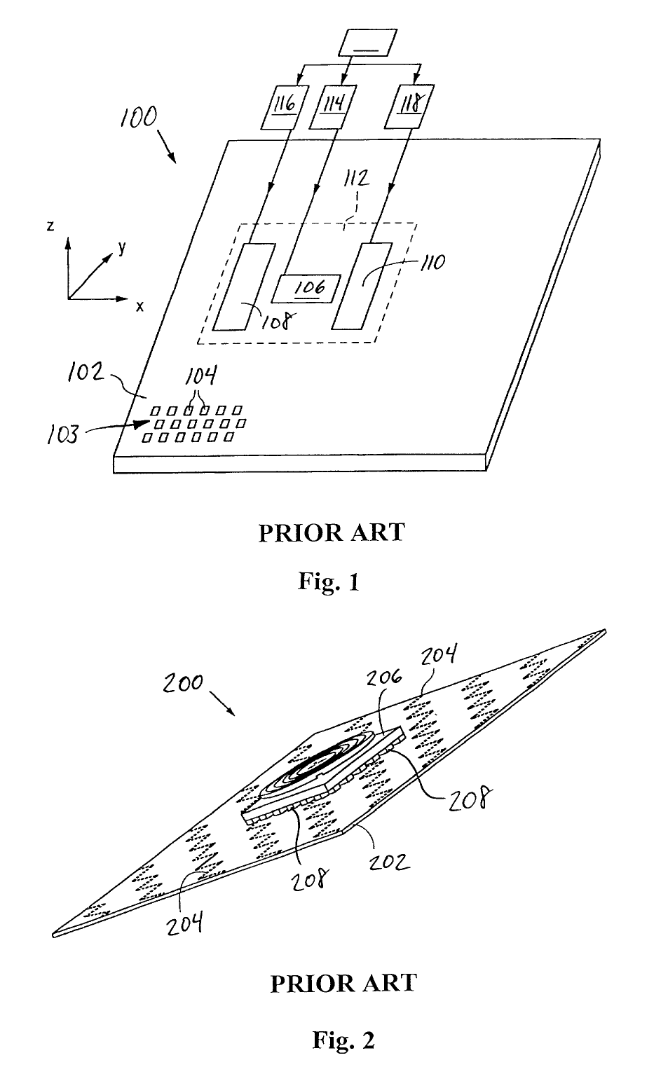

### DETAILED DESCRIPTION OF THE PREFERRED EMBODIMENT

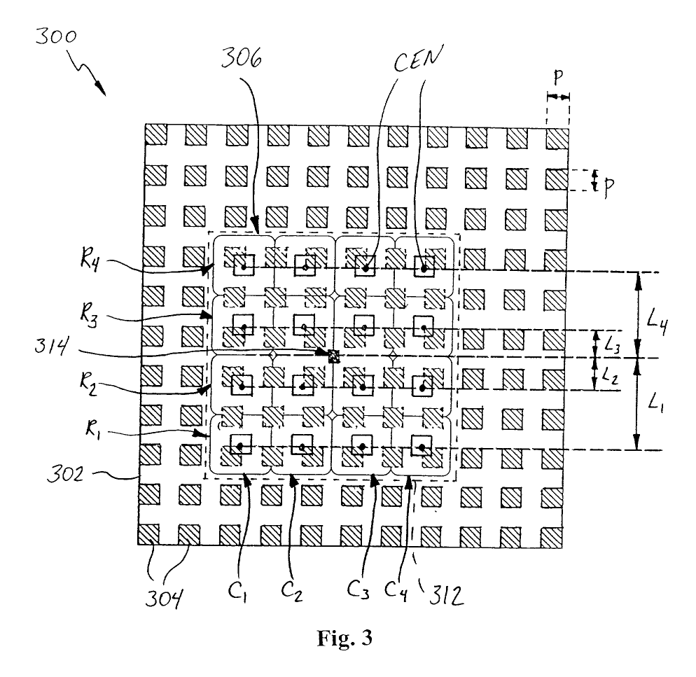

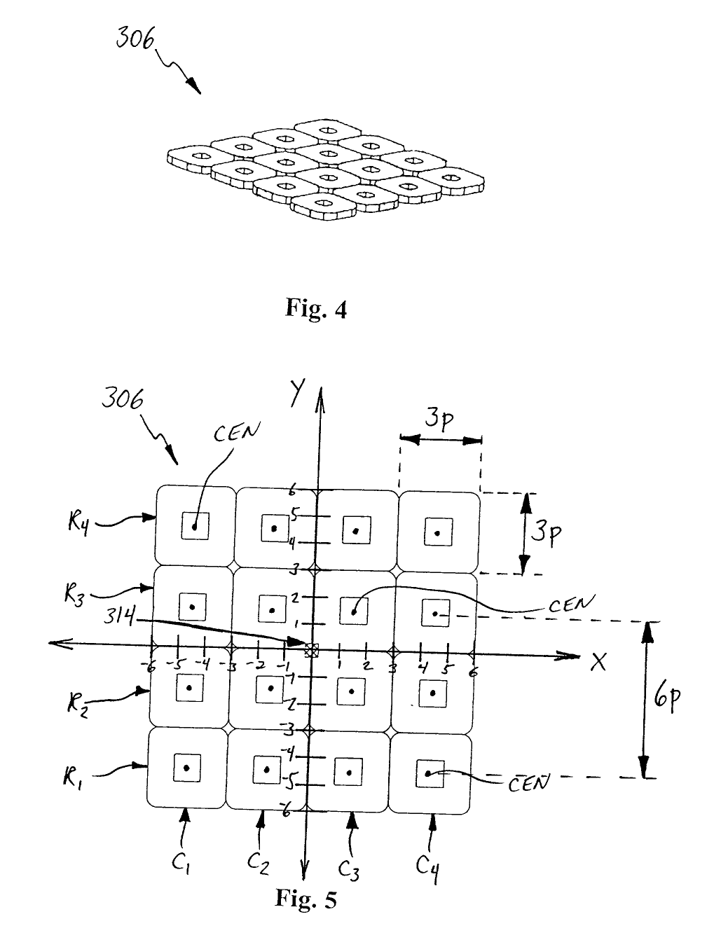

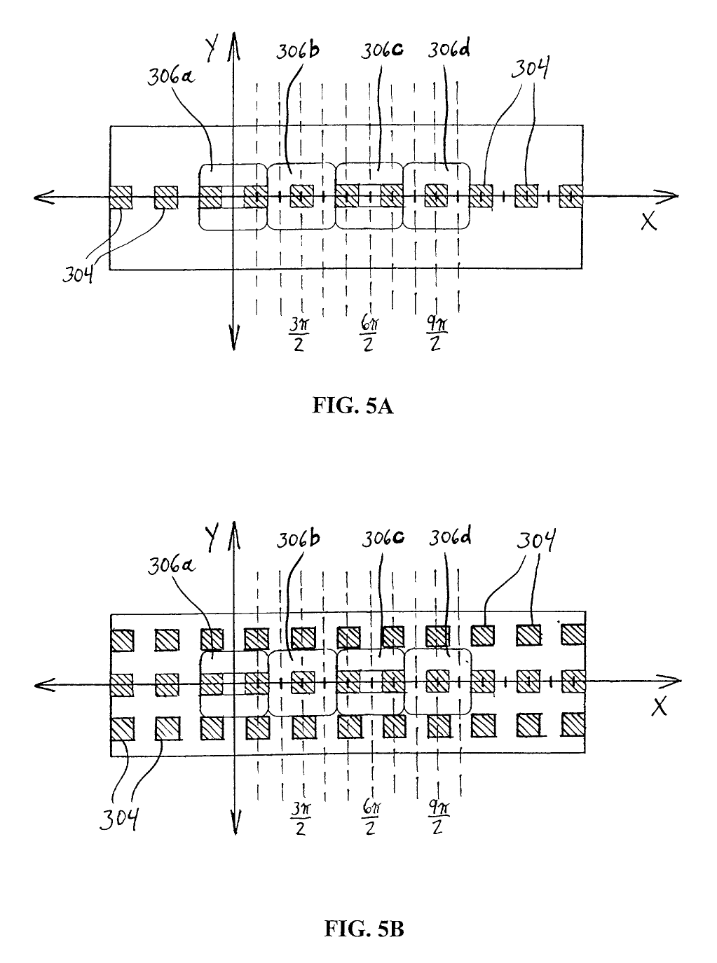

Referring initially to FIGS. 3-5, a moving coil planar motor 300 is shown, and includes a base with a flat magnet array 302 having a plurality of magnets 304. Moving coil planar motors suitable for the present invention are disclosed, for example, in U.S. Pat. No. 6,097,114 to Hazelton, the content of which is hereby incorporated by reference in its entirety. Coils 306 are provided for attachment to the underside of a stage frame 312 (drawn in dashed lines) for suspension above magnet array 302. Coils 306 form a square, flat-type coil similar to that used in moving magnet planar motor stages. In a preferred embodiment, coils 306 are disposed in a 4×4 square array about a center of gravity or origin 314, with four coils in each column C₁, C₂, C₃, C₄, and four coils in each row R₁, R₂, R₃, R₄, thus forming an array of 16 coils. As will be described shortly, such an array of coils 306 permits planar motor control in 3 degrees of freedom—x- and y-translation and z-rotation. Each magnet 304 has a length of about one pitch, p, which is defined as the length of the side of a magnet 304 as shown in FIG. 3. Thus, each magnet has an area of about one pitch squared (p²). A perspective view of coils 306 is shown in FIG. 4. Referring to FIG. 5, each coil has a length 3p, as shown graphically. Coils 306 used in a moving coil planar motor 300 permit movement from −3 to +3 pitches in both the x- and y-directions. Persons of ordinary skill in the art will appreciate that the present invention may be readily adapted to control coil arrays of different dimensions based on the teachings set forth herein.

Translation forces as well as torques are controlled by the four coils in each column C₁, C₂, C₃, C₄, and the four coils in each row R₁, R₂, R₃, R₄. Translation force Fₓ in the x-direction of FIG. 5 is generated by the rows R₁, R₂, R₃, R₄ of coils disposed parallel to the x-direction. In addition, the coils in rows R₁, R₂, R₃, R₄ generate about half of the torque T_{z} in the z-direction, which is perpendicular to the plane of the page, and for example extends from origin 314. Another translation force F_{y} in the y-direction of FIG. 5 is generated by the columns C₁, C₂, C₃, C₄ of coils disposed parallel to the y-direction, which also account for the other half of the torque T_{z} in the z-direction.

In order to describe the benefits of the control scheme permitted by the coil array of FIGS. 3-5, each of coils 306 are disposed about a center point CEN located at an (x,y) position, measured in units of pitch, along axes x, y. Each of the 16 coils may thus be identified in terms of its location in the array (row, column) and the location of its center point CEN with respect to origin 314 (x, y). Thus, the sixteen coils are initially described as follows:

(R₁,C₁):(−4.5,−4.5);(R₁,C₂):(−1.5,−4.5);(R₁,C₃):(+1.5,−4.5);(R₁,C₄):(+4.5,−4.5) (1)

(R₂,C₁):(−4.5,−1.5);(R₂,C₂):(−1.5,−1.5);(R₂,C₃):(+1.5,−1.5);(R₂,C₄):(+4.5,−1.5) (2)

(R₃,C₁):(−4.5,+1.5);(R₃,C₂):(−1.5,+1.5);(R₃,C₃):(+1.5,+1.5);(R₃,C₄):(+4.5,+1.5) (3)

(R₄,C₁):(−4.5,+4.5);(R₄,C₂):(−1.5,+4.5);(R₄,C₃):(+1.5,+4.5);(R₄,C₄):(+4.5,+4.5) (4)

Movement of each of coils 306 by +0.5 pitch along the x-axis and −0.5 pitch along the y-axis thus results in the following new positions:

(R₁,C₁):(−4,−5);(R₁,C₂):(−1,−5);(R₁,C₃):(+2,−5);(R₁,C₄):(+5,−5) (5)

(R₂,C₁):(−4,−2);(R₂,C₂):(−1,−2);(R₂,C₃):(+2,−2);(R₂,C₄):(+5,−2) (6)

(R₃,C₁):(−4,+1);(R₃,C₂):(−1,+1);(R₃,C₃):(+2,+1);(R₃,C₄):(+5,+1) (7)

(R₄,C₁):(−4,+4);(R₄,C₂):(−1,+4);(R₄,C₃):(+2,+4);(R₄,C₄):(+5,+4) (8)

With these positions, the magnet force constant, kₘ, that is located under a group of coils is determined for the coils in rows R₁, R₂, R₃, R₄ as follows:

For R₁: kₘ_{ₘ}:=kₘ(ptₓ₍ₙ_{ᵢ}₎,pt_{y(n}_{₁}₎⁻⁵) (9)

For R₂: kₘ_{ₘ}:=kₘ(ptₓ₍ₙ_{ᵢ}₎,pt_{y(n}_{ᵢ}₎−2) (10)

For R₃: kₘ_{ₘ}:=kₘ(ptₓ₍ₙ_{ᵢ}₎,pt_{y(n}_{ᵢ}₎+1) (11)

For R₄: kₘ_{ₘ}:=kₘ(ptₓ₍ₙ_{ᵢ}₎,pt_{y(n}_{ᵢ}₎+4) (12)

here ptₓ₍ₙ_{ᵢ}₎ and pt_{y(n}_{ᵢ}₎ are the number of pitch of each of the four coils in the row in the x-and y-directions, respectively.

In particular, using row R₃ as the starting row for these calculations, the magnetic force constant for rows R₁, R₂, R₄ may be determined by accounting for the offset distance value between row R₃ and the desired row R₁, R₂, R₄. Thus, the magnet force constant located under row R₁ is calculated by noting that the offset distance in the y-direction between the center points CEN of a coil in row R₃ and a coil in row R₁ is 6 pitches. This is due to the fact that the distance in the y-direction from the center points CEN of a coil in row R₃ and a coil in row R₁ is −6 pitches. The distances of rows R₁, R₂, R₄ from row R₃ are −6 pitches, −3 pitches, and +3 pitches, respectively.

The magnetic force constant located under each of the moving coils in row R₃ is described by the following matrices:

$$\begin{matrix}For ( {R}_{3} , {C}_{1} ) : {k}_{m} ( {x}_{1} , {y}_{1} ) := [ \begin{matrix}{k}_{x} cos ( {x}_{1} \frac{π}{2} - 4.5 \frac{π}{2} ) sin ( {y}_{1} \frac{π}{2} + 1.5 \frac{π}{2} ) \\ {k}_{y} sin ( {x}_{1} \frac{π}{2} - 4.5 \frac{π}{2} ) cos ( {y}_{1} \frac{π}{2} + 1.5 \frac{π}{2} ) \\ 0\end{matrix} ] & ( 13 ) \\ For ( {R}_{3} , {C}_{2} ) : {k}_{m} ( {x}_{1} , {y}_{1} ) := [ \begin{matrix}{k}_{x} cos ( {x}_{1} \frac{π}{2} - 1.5 \frac{π}{2} ) sin ( {y}_{1} \frac{π}{2} + 1.5 \frac{π}{2} ) \\ {k}_{y} sin ( {x}_{1} \frac{π}{2} - 1.5 \frac{π}{2} ) cos ( {y}_{1} \frac{π}{2} + 1.5 \frac{π}{2} ) \\ 0\end{matrix} ] & ( 14 ) \\ For ( {R}_{3} , {C}_{3} ) : {k}_{m} ( {x}_{1} , {y}_{1} ) := [ \begin{matrix}{k}_{x} cos ( {x}_{1} \frac{π}{2} + 1.5 \frac{π}{2} ) sin ( {y}_{1} \frac{π}{2} + 1.5 \frac{π}{2} ) \\ {k}_{y} sin ( {x}_{1} \frac{π}{2} + 1.5 \frac{π}{2} ) cos ( {y}_{1} \frac{π}{2} + 1.5 \frac{π}{2} ) \\ 0\end{matrix} ] & ( 15 ) \\ For ( {R}_{3} , {C}_{4} ) : {k}_{m} ( {x}_{1} , {y}_{1} ) := [ \begin{matrix}{k}_{x} cos ( {x}_{1} \frac{π}{2} + 4.5 \frac{π}{2} ) sin ( {y}_{1} \frac{π}{2} + 1.5 \frac{π}{2} ) \\ {k}_{y} sin ( {x}_{1} \frac{π}{2} + 4.5 \frac{π}{2} ) cos ( {y}_{1} \frac{π}{2} + 1.5 \frac{π}{2} ) \\ 0\end{matrix} ] & ( 16 )\end{matrix}$$

Equations 13-16 may be modified to describe the coils in rows R₁,R₂,R₄ by accounting for the offset distance from row R₃, as presented in equations 5-8, and thus the magnetic force constant for the moving coil planar motor 300 may be determined.

Similar to a moving magnet planar motor, commutation of the exemplar moving coil planar motor can be analyzed with 4-phase linear motor equations. As shown in FIG. 5A, a four-phase motor includes four coils 306a, 306b, 306c, 306d, as well as one row of magnets 304 each separated by a distance of one pitch, corresponding to a phase difference φ of π/2 radians between phases. In this arrangement of coils 306a, 306b, 306c, 306d and magnets 304, one degree of freedom is provided, along the x-axis. The magnet force constant for coils 306a, 306b, 306c, 306d is determined as follows:

$$\begin{matrix}{k}_{x} ( pitch ) = {k}_{x} sin ( pitch + φ ) \\ = {k}_{x} sin ( x + 0 ) ( coil 306 a ) \\ = {k}_{x} sin ( x + \frac{3 π}{2} ) ( coil 306 b ) \\ = {k}_{x} sin ( x + \frac{6 π}{2} ) ( coil 306 c ) \\ = {k}_{x} sin ( x + \frac{9 π}{2} ) ( coil 306 d ) \\ = {k}_{x} sin ( x ) - {k}_{x} cos ( x ) - {k}_{x} sin ( x ) - {k}_{x} cos ( x )\end{matrix} \qquad ( 17 )$$

The commutation current associated with each of coils 306a, 306b, 306c, 306d is found as:

$$\begin{matrix}{I}_{x} ( pitch ) = {I}_{x} sin ( pitch + φ ) \\ = {I}_{x} sin ( x + 0 ) ( coil 306 a ) \\ = {I}_{x} sin ( x + \frac{3 π}{2} ) ( coil 306 b ) \\ = {I}_{x} sin ( x + \frac{6 π}{2} ) ( coil 306 c ) \\ = {I}_{x} sin ( x + \frac{9 π}{2} ) ( coil 306 d ) \\ = {I}_{x} sin ( x ) - {I}_{x} cos ( x ) - {I}_{x} sin ( x ) - {I}_{x} cos ( x )\end{matrix} \qquad ( 18 )$$

Using the four phase magnet force constant, four phase commutation produces a constant force regardless of stage position:

$$\begin{matrix}F = {k}_{x} {I}_{x} sin ( x ) sin ( x ) + {k}_{x} {I}_{x} cos ( x ) cos ( x ) + \\ {k}_{x} {I}_{x} sin ( x ) sin ( x ) + {k}_{x} {I}_{x} cos ( x ) cos ( x ) \\ = {k}_{x} {I}_{x} {sin}^{2} ( x ) + {k}_{x} {I}_{x} {cos}^{2} ( x ) + \\ {k}_{x} {I}_{x} {sin}^{2} ( x ) + {k}_{x} {I}_{x} {cos}^{2} ( x ) \\ = 2 {k}_{x} {I}_{x}\end{matrix} \qquad ( 19 )$$

Next, an arrangement of coils 306a, 306b, 306c, 306d and magnets 304 for providing two degrees of freedom, along the x- and y-axes, is shown in FIG. 5B. In this instance, the magnet force constant for coils 306a, 306b, 306c, 306d is determined as follows:

$$\begin{matrix}{k}_{xy} ( {pitch}_{x} , {pitch}_{y} ) = {k}_{xy} sin ( x + 0 ) cos ( y ) ( coil 306 a ) \\ = {k}_{xy} sin ( x + \frac{3 π}{2} ) cos ( y ) ( coil 306 b ) \\ = {k}_{xy} sin ( x + \frac{6 π}{2} ) cos ( y ) ( coil 306 c ) \\ = {k}_{xy} sin ( x + \frac{9 π}{2} ) cos ( y ) ( coil 306 d )\end{matrix} \qquad ( 20 )$$

Again, the commutation current associated with each of coils 306a, 306b, 306c, 306d is found as:

$$\begin{matrix}{I}_{xy} ( {pitch}_{x} , {pitch}_{y} ) = {I}_{xy} sin ( x + 0 ) cos ( y ) ( coil 306 a ) \\ = {I}_{xy} sin ( x + \frac{3 π}{2} ) cos ( y ) ( coil 306 b ) \\ = {I}_{xy} sin ( x + \frac{6 π}{2} ) cos ( y ) ( coil 306 c ) \\ = {I}_{xy} sin ( x + \frac{9 π}{2} ) cos ( y ) ( coil 306 d )\end{matrix} \qquad ( 21 )$$

Similarly, four phase commutation for two degrees of freedom produces a constant force regardless of stage position:

$$\begin{matrix}F = {k}_{xy} {I}_{xy} sin ( x ) sin ( x ) {cos}^{2} ( y ) + {k}_{xy} {I}_{xy} cos ( x ) cos ( x ) {cos}^{2} ( y ) + \\ {k}_{xy} {I}_{xy} sin ( x ) sin ( x ) {cos}^{2} + {k}_{xy} {I}_{xy} cos ( x ) cos ( x ) {cos}^{2} ( y ) \\ = 2 {k}_{xy} {I}_{xy} [ {sin}^{2} ( x ) + {cos}^{2} ( x ) ] {cos}^{2} ( y ) \\ = 2 {k}_{xy} {I}_{xy} {cos}^{2} ( y )\end{matrix} \qquad ( 22 )$$

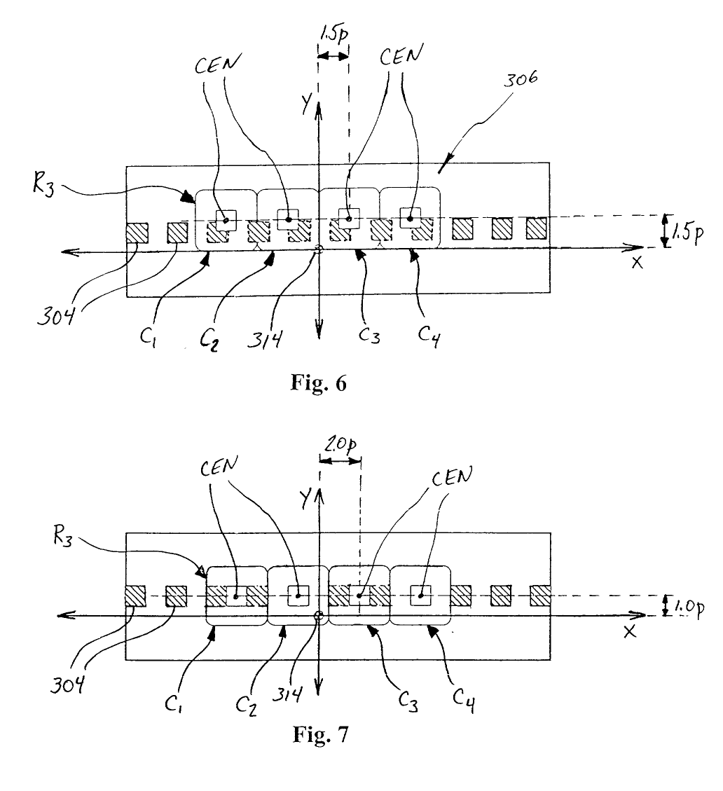

Following the aforementioned approach incorporating the four phase motor equation, commutation with one degree of freedom again may be analyzed for a group of coils 306, shown in a different position in FIG. 6, to further demonstrate the creation of a constant translation force at a given position. In particular, it is noted that in this construction, the center points CEN of coils 306 in row R₃ are offset in the y-direction by a distance 1.5 pitch (1.5p) from the x-axis through origin 314. The magnet force constant in the x-direction for row R₃ is represented by the first row of each of the matrices in equations 13-16. Also, the coil 306 located at position (R₃, C₃) is offset in the x-direction by a distance 1.5 pitch (1.5p) from the y-axis through origin 314, while the offsets for the other coils do not fall at a whole number of pitch. For the purposes of this exemplar analysis, non-whole number offsets, present in both the x- and y-directions, unnecessarily complicate the explanation due to the sine and cosine behavior, and thus it is desirable to present an analysis with coils 306 whose center points CEN are located in both the x- and y-directions at a whole number of pitch.

Turning to FIG. 7, in order to demonstrate commutation of the exemplar moving coil planar motor 300, coils 306 in row R₃ have been moved such that their center points CEN are offset in the y-direction by a distance 1.0 pitch (1.0p) from the x-axis through origin 314. In addition, the coil 306 located at position (R₃, C₃) has been moved to an offset in the x-direction by a distance 2.0 pitch (2.0p) from the y-axis through origin 314, with the offsets for the other coils 306 also set at a whole number of pitch. With this new alignment, the magnet force constants in the x-direction for coils 306 in row R₃ are as follows:

$$\begin{matrix}\begin{matrix}For ( {R}_{3} , {C}_{1} ) : {k}_{m} ( {x}_{1} ) = {k}_{xy} cos ( x - 4 \frac{π}{2} ) sin ( y + \frac{π}{2} ) \\ = {k}_{xy} cos ( x ) cos ( y ) ;\end{matrix} & ( 23 ) \\ \begin{matrix}For ( {R}_{3} , {C}_{2} ) : {k}_{m} ( {x}_{1} ) = {k}_{xy} cos ( x - 1 \frac{π}{2} ) sin ( y + \frac{π}{2} ) \\ = {k}_{xy} sin ( x ) cos ( y ) ;\end{matrix} & ( 24 ) \\ \begin{matrix}For ( {R}_{3} , {C}_{3} ) : {k}_{m} ( {x}_{1} ) = {k}_{xy} cos ( x + 2 \frac{π}{2} ) sin ( y + \frac{π}{2} ) \\ = - {k}_{xy} cos ( x ) cos ( y ) ;\end{matrix} & ( 25 ) \\ \begin{matrix}For ( {R}_{3} , {C}_{4} ) : {k}_{m} ( {x}_{1} ) = {k}_{xy} cos ( x + 5 \frac{π}{2} ) sin ( y + \frac{π}{2} ) \\ = = - {k}_{xy} sin ( x ) cos ( y ) .\end{matrix} & ( 26 )\end{matrix}$$

A constant translation force is obtained for coils 306 by providing a physical coil current, I, and this current for each of coils 306 at positions (R₃, C₁), (R₃, C₂), (R₃, C₃), and (R₃, C₄) is:

$$\begin{matrix}\begin{matrix}{I}_{( {R}_{3} , {C}_{1} )} = [ {I}_{x} cos ( x - 4 \frac{π}{2} ) sin ( y + \frac{π}{2} ) + \\ {I}_{y} cos ( y + \frac{π}{2 } ) sin ( x - 4 \frac{π}{2} ) ] \\ = {I}_{x } cos ( x ) cos ( y ) - {I}_{y} sin ( y ) sin ( x ) ;\end{matrix} & ( 27 ) \\ \begin{matrix}{I}_{( {R}_{3} , {C}_{2} )} = [ {I}_{x} cos ( x - 1 \frac{π}{2} ) sin ( y + \frac{π}{2} ) + \\ {I}_{y} cos ( y + \frac{π}{2} ) sin ( x - 1 \frac{π}{2} ) ] \\ = {I}_{x } sin ( x ) cos ( y ) + {I}_{y} sin ( y ) cos ( x ) ;\end{matrix} & ( 28 ) \\ \begin{matrix}{I}_{( {R}_{3 } , {C}_{3} )} = [ {I}_{x} cos ( x + 2 \frac{π}{2} ) sin ( y + \frac{π}{2} ) + \\ {I}_{y} cos ( y + \frac{π}{2} ) sin ( x + 2 \frac{π}{2} ) ] \\ = - {I}_{x} cos ( x ) cos ( y ) + {I}_{y} sin ( y ) sin ( x ) ;\end{matrix} & ( 29 ) \\ \begin{matrix}{I}_{( {R}_{3} , {C}_{4} )} = [ {I}_{x} cos ( x + 5 \frac{π}{2} ) sin ( y + \frac{π}{2} ) + \\ {I}_{y} cos ( y + \frac{π}{2} ) sin ( x + 5 \frac{π}{2} ) ] \\ = - {I}_{x} sin ( x ) cos ( y ) - {I}_{y} sin ( y ) cos ( x ) .\end{matrix} & ( 30 )\end{matrix}$$

The translation force is the product obtained by multiplying each of the aforementioned magnet force constants by its respective commutation current. For example, in the x-direction the force for the coils in row R₃ is found as follows:

$$\text{For} {R}_{s} \text{:} \\ \begin{matrix}{F}_{x} = {k}_{xy} cos ( x - 4 \frac{π}{2} ) sin ( y + \frac{π}{2} ) [ {I}_{x} cos ( x - 4 \frac{π}{2} ) sin ( y + \frac{π}{2} ) + \\ {I}_{y} cos ( y + \frac{π}{2} ) sin ( x - 4 \frac{π}{2} ) ] + \\ {k}_{xy} cos ( x - 1 \frac{π}{2} ) sin ( y + \frac{π}{2} ) [ {I}_{x} cos ( x - 1 \frac{π}{2} ) sin ( y + \frac{π}{2} ) + \\ {I}_{y} cos ( y + \frac{π}{2} ) sin ( x - 1 \frac{π}{2} ) ] + \\ {k}_{xy} cos ( x + 2 \frac{π}{2} ) sin ( y + \frac{π}{2} ) [ {I}_{x} cos ( x + 2 \frac{π}{2} ) sin ( y + \frac{π}{2} ) + \\ {I}_{y} cos ( y + \frac{π}{2} ) sin ( x + 2 \frac{π}{2} ) ] + \\ {k}_{xy} cos ( x + 5 \frac{π}{2} ) sin ( y + \frac{π}{2} ) [ {I}_{x} cos ( x + 5 \frac{π}{2} ) sin ( y + \frac{π}{2} ) + \\ {I}_{y} cos ( y + \frac{π}{2} ) sin ( x + 5 \frac{π}{2} ) ] \\ = {k}_{xy} cos ( x ) sin ( y ) [ {I}_{x} cos ( x ) cos ( y ) - {I}_{y} sin ( y ) sin ( x ) ] + \\ {k}_{xy} sin ( x ) cos ( y ) [ {I}_{x} sin ( x ) cos ( y ) + {I}_{y} sin ( y ) cos ( x ) ] + \\ - {k}_{xy } cos ( x ) cos ( y ) [ - {I}_{x} cos ( x ) cos ( y ) + {I}_{y} sin ( y ) sin ( x ) + \\ - {k}_{xy} sin ( x ) cos ( y ) [ - {I}_{x} sin ( x ) cos ( y ) - {I}_{y} sin ( y ) cos ( x ) ] \\ = {k}_{xy} {I}_{x} {cos}^{2} ( x ) {cos}^{2} ( y ) - {k}_{x} {I}_{y} cos ( x ) cos ( y ) sin ( y ) sin ( x ) + \\ {k}_{xy} {I}_{x} {sin}^{2} ( x ) {cos}^{2} ( y ) + {k}_{x} {I}_{y} cos ( x ) cos ( y ) sin ( y ) sin ( x ) + \\ {k}_{xy} {I}_{x} {cos}^{2} ( x ) {cos}^{2} ( y ) - {k}_{x} {I}_{y} cos ( x ) cos ( y ) sin ( y ) sin ( x ) + \\ {k}_{xy} {I}_{x} {sin}^{2} ( x ) {cos}^{2} ( y ) + {k}_{x} {I}_{y} cos ( x ) cos ( y ) sin ( y ) sin ( x ) + \\ = {k}_{xy} {I}_{x} {cos}^{2} ( y ) [ {cos}^{2} ( x ) + {sin}^{2} ( x ) ] + \\ {k}_{xy} {I}_{x} {cos}^{2} ( y ) [ {cos}^{2} ( x ) + {sin}^{2} ( x ) ] \\ = 2 {I}_{x} {k}_{xy} {cos}^{2} ( y )\end{matrix} \qquad ( 31 )$$

where Iₓ represents the x-direction control current in amperes, I_{y} represents the y-direction control current in amperes, and k_{xy} represents the planar magnet force constant in Newtons, ampere.

The calculation performed above may be repeated for each of coils 306 in rows R₁, R₂, R₃, R₄, and thus the translation forces in the x-direction due to the coils 306 in each of the rows are as follows:

For R₁: Fₓ₁=2Iₓkₐ cos²(y) (32)

For R₂: Fₓ₂=2Iₓkₐ sin²(y) (33)

For R₃: Fₓ₃=2Iₓkₐ cos²(y) (34)

For R₄: Fₓ₄=2Iₓkₐ sin²(y) (35)

where force constant kₐ is the same as force constant k_{xy}. The total translation force provided by the coils 306 is the summation of the translation forces provided by each of the rows R₁, R₂, R₃, R₄, and simplifies to:

Fₓ_{ₜₒₜₐₗ}=4Iₓkₐ (36)

The total translation force in the y-direction may also be found in the same fashion, and simplifies to:

F_{y}=4I_{y}kₐ (37)

It is desirable to provide torque or yaw control (θ_{z}) for the moving coil planar magnet so that control of a third degree of freedom complements the x- and y-direction translational force control already discussed. In order to calculate torque, the distance from each of the coils to the center of gravity of the coil array must be known. To this end, referring again to FIG. 3, it is noted that the distances between each of coils 306 are fixed. Thus, as shown in FIG. 3, the center points CEN of coils 306 in rows R₁ and R₄ are offset in the y-direction by distances L₁, L₄ of −4.5 pitch (−4.5 p) and 4.5 pitch (4.5 p), respectively, from the x-axis that extends through origin 314, while the center points CEN of coils 306 in rows R₂ and R₃ are offset by distances L₂, L₃ of −1.5 pitch (−1.5 p) and 1.5 pitch (1.5 p), respectively. To create torque, current +Iₜ is applied to coils 306 in rows R₃ and R₄, while current Iₜ is applied to coils 306 in rows R₁ and R₂, such that the following torque-related translation forces are generated:

For R₁: T₁=L₁[2Iₜkₐ cos²(y)] (38)

For R₂: T₂=L₂[2Iₜkₐ sin²(y)] (39)

For R₃: T₃=L₃[2(−Iₜ)kₐ cos²(y)] (40)

For R₄: T₄=L₄[2(−Iₜ)kₐ sin²(y)] (41)

The y-term in Equations 38 to 41 is zero for the stage at the origin in FIG. 3. Next, substituting the know offset distances L₁-L₄ and adding torque contributions T₁-T₄, the total torque is found as:

$$\begin{matrix}{T}_{total} = - 4.5 [ 2 {I}_{t} {k}_{a} {cos}^{2} ( y ) ] - 1.5 [ 2 {I}_{t} {k}_{a} {sin}^{2} ( y ) ] + \\ 1.5 [ 2 ( - {I}_{t} ) {k}_{a} {cos}^{2} ( y ) ] + 4.5 [ 2 ( - {I}_{t} ) {k}_{a} {sin}^{2} ( y ) ] \\ = - 3 {I}_{t} {k}_{a} [ {sin}^{2} ( y ) + {cos}^{2} ( y ) ] - 9 {I}_{t} {k}_{a} [ {sin}^{2} ( y ) + {cos}^{2} ( y ) ] \\ = - 12 {I}_{t} {k}_{a}\end{matrix} \qquad ( 42 )$$

Thus, the components of torque from the rows of coils 306 produce the following torque with units of Newton-pitch:

torque_{row}=12Iₜ_{ₓ}kₐ (43)

Similarly, the components of torque from the columns of coils 306 produce the following torque with units of Newton-pitch:

torque_{column}=12Iₜ_{_{y}}kₐ (44)

The force and torque expressions above can be solved to give the coil current for the x- and y-translation forces and torque, related to control in three degrees of freedom using 16 coils, as follows:

$$\begin{matrix}{I}_{x} = \frac{{F}_{x}}{4 {k}_{a}} ; & ( 45 ) \\ {I}_{y} = \frac{{F}_{y}}{4 {k}_{a}} ; & ( 46 ) \\ {I}_{{t}_{x}} = \frac{Torque}{12 {k}_{a}} & ( 47 )\end{matrix}$$

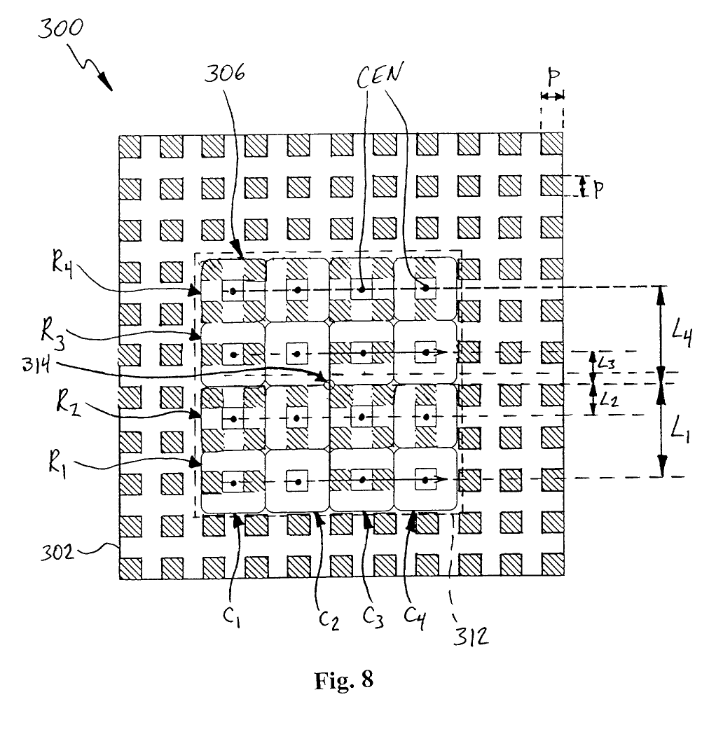

With the above relations established, simultaneous production of x- and y-translation forces as well as torque (θ_{z}) can be considered, so that the control movement for all three degrees of freedom can be determined. For an array of coils 306 as disposed in FIG. 8, with the stage shifted from the origin position of FIG. 3, the translation forces can be calculated. For example, row R₁ of coils 306 have coordinates (−4,−5), (−1,−5), (2,−5), and (5,−5). The coordinates, along with the commutation functions for translation force and torque of coils 306 in the row (represented in brackets), are used to determine the translation force as follows:

$$\text{For} {R}_{1} \text{:} \\ \begin{matrix}{F}_{x} = {k}_{x} cos ( x - 4 \frac{π}{2} ) sin ( y - 5 \frac{π}{2} ) [ \begin{matrix}( {I}_{x } + {I}_{{t}_{x}} ) cos ( x - 4 \frac{π}{2} ) sin ( y - 5 \frac{π}{2} ) + \\ ( {I}_{y} + {I}_{{t}_{y}} ) cos ( y - 5 \frac{π}{2} ) sin ( x - 4 \frac{π}{2} )\end{matrix} ] + \\ {k}_{x} cos ( x - 1 \frac{π}{2} ) sin ( y - 5 \frac{π}{2} ) [ \begin{matrix}( {I}_{x } + {I}_{{t}_{x}} ) cos ( x - 1 \frac{π}{2} ) sin ( y - 5 \frac{π}{2} ) + \\ ( {I}_{y} + {I}_{{t}_{y}} ) cos ( y - 5 \frac{π}{2} ) sin ( x - 1 \frac{π}{2} )\end{matrix} ] + \\ {k}_{x} cos ( x + 2 \frac{π}{2} ) sin ( y - 5 \frac{π}{2} ) [ \begin{matrix}( {I}_{x } + {{I}_{t}}_{x} ) cos ( x + 2 \frac{π}{2} ) sin ( y - 5 \frac{π}{2} ) + \\ ( {I}_{y} + {I}_{{t}_{y}} ) cos ( y - 5 \frac{π}{2} ) sin ( x + 2 \frac{π}{2} )\end{matrix} ] + \\ {k}_{x} cos ( x + 5 \frac{π}{2} ) sin ( y - 5 \frac{π}{2} ) [ \begin{matrix}( {I}_{x } + {I}_{{t}_{x}} ) cos ( x + 5 \frac{π}{2} ) sin ( y - 5 \frac{π}{2} ) + \\ ( {I}_{y} + {I}_{{t}_{y}} ) cos ( y - 5 \frac{π}{2} ) sin ( x + 5 \frac{π}{2} )\end{matrix} ] \\ = 2 {I}_{x} {k}_{x} {cos}^{2} ( y ) + 2 {I}_{{t}_{x}} {k}_{x } {cos}^{2} ( y )\end{matrix} \qquad ( 48 )$$

The translation forces for the remaining rows are as follows:

$$\begin{matrix}\text{For} {R}_{2} \text{:} \\ \begin{matrix}{F}_{x} = {k}_{x} cos ( x - 4 \frac{π}{2} ) sin ( y - 2 \frac{π}{2} ) [ \begin{matrix}( {I}_{x } + {I}_{{t}_{x}} ) cos ( x - 4 \frac{π}{2} ) sin ( y - 2 \frac{π}{2} ) + \\ ( {I}_{y} + {I}_{{t}_{y}} ) cos ( y - 2 \frac{π}{2} ) sin ( x - 4 \frac{π}{2} )\end{matrix} ] + \\ {k}_{x} cos ( x - 1 \frac{π}{2} ) sin ( y - 2 \frac{π}{2} ) [ \begin{matrix}( {I}_{x } + {I}_{{t}_{x}} ) cos ( x - 1 \frac{π}{2} ) sin ( y - 2 \frac{π}{2} ) + \\ ( {I}_{y} + {I}_{{t}_{y}} ) cos ( y - 2 \frac{π}{2} ) sin ( x - 1 \frac{π}{2} )\end{matrix} ] + \\ {k}_{x} cos ( x + 2 \frac{π}{2} ) sin ( y - 2 \frac{π}{2} ) [ \begin{matrix}( {I}_{x } + {{I}_{t}}_{x} ) cos ( x + 2 \frac{π}{2} ) sin ( y - 2 \frac{π}{2} ) + \\ ( {I}_{y} + {I}_{{t}_{y}} ) cos ( y - 2 \frac{π}{2} ) sin ( x + 2 \frac{π}{2} )\end{matrix} ] + \\ {k}_{x} cos ( x + 5 \frac{π}{2} ) sin ( y - 2 \frac{π}{2} ) [ \begin{matrix}( {I}_{x } + {I}_{{t}_{x}} ) cos ( x + 5 \frac{π}{2} ) sin ( y - 2 \frac{π}{2} ) + \\ ( {I}_{y} + {I}_{{t}_{y}} ) cos ( y - 2 \frac{π}{2} ) sin ( x + 5 \frac{π}{2} )\end{matrix} ] \\ = 2 {I}_{x} {k}_{x} {sin}^{2} ( y ) + 2 {I}_{{t}_{x}} {k}_{x } {sin}^{2} ( y )\end{matrix} & ( 49 ) \\ \text{For} {R}_{3} \text{:} \\ \begin{matrix}{F}_{x} = {k}_{x} cos ( x - 4 \frac{π}{2} ) sin ( y + 1 \frac{π}{2} ) [ \begin{matrix}( {I}_{x } - {I}_{{t}_{x}} ) cos ( x - 4 \frac{π}{2} ) sin ( y + 1 \frac{π}{2} ) + \\ ( {I}_{y} - {I}_{{t}_{y}} ) cos ( y + 1 \frac{π}{2} ) sin ( x - 4 \frac{π}{2} )\end{matrix} ] + \\ {k}_{x} cos ( x - 1 \frac{π}{2} ) sin ( y + 1 \frac{π}{2} ) [ \begin{matrix}( {I}_{x } - {I}_{{t}_{x}} ) cos ( x - 1 \frac{π}{2} ) sin ( y + 1 \frac{π}{2} ) + \\ ( {I}_{y} - {I}_{{t}_{y}} ) cos ( y + 1 \frac{π}{2} ) sin ( x - 1 \frac{π}{2} )\end{matrix} ] + \\ {k}_{x} cos ( x + 2 \frac{π}{2} ) sin ( y + 1 \frac{π}{2} ) [ \begin{matrix}( {I}_{x } - {{I}_{t}}_{x} ) cos ( x + 2 \frac{π}{2} ) sin ( y + 1 \frac{π}{2} ) + \\ ( {I}_{y} - {I}_{{t}_{y}} ) cos ( y + 1 \frac{π}{2} ) sin ( x + 2 \frac{π}{2} )\end{matrix} ] + \\ {k}_{x} cos ( x + 5 \frac{π}{2} ) sin ( y + 1 \frac{π}{2} ) [ \begin{matrix}( {I}_{x } - {I}_{{t}_{x}} ) cos ( x + 5 \frac{π}{2} ) sin ( y + 1 \frac{π}{2} ) + \\ ( {I}_{y} - {I}_{{t}_{y}} ) cos ( y + 1 \frac{π}{2} ) sin ( x + 5 \frac{π}{2} )\end{matrix} ] \\ = 2 {I}_{x} {k}_{x} {cos}^{2} ( y ) - 2 {I}_{{t}_{x}} {k}_{x } {cos}^{2} ( y )\end{matrix} & ( 50 ) \\ \text{For} {R}_{4} \text{:} \\ \begin{matrix}{F}_{x} = {k}_{x} cos ( x - 4 \frac{π}{2} ) sin ( y + 4 \frac{π}{2} ) [ \begin{matrix}( {I}_{x } - {I}_{{t}_{x}} ) cos ( x - 4 \frac{π}{2} ) sin ( y + 4 \frac{π}{2} ) + \\ ( {I}_{y} - {I}_{{t}_{y}} ) cos ( y + 4 \frac{π}{2} ) sin ( x - 4 \frac{π}{2} )\end{matrix} ] + \\ {k}_{x} cos ( x - 1 \frac{π}{2} ) sin ( y + 4 \frac{π}{2} ) [ \begin{matrix}( {I}_{x } - {I}_{{t}_{x}} ) cos ( x - 1 \frac{π}{2} ) sin ( y + 4 \frac{π}{2} ) + \\ ( {I}_{y} - {I}_{{t}_{y}} ) cos ( y + 4 \frac{π}{2} ) sin ( x - 1 \frac{π}{2} )\end{matrix} ] + \\ {k}_{x} cos ( x + 2 \frac{π}{2} ) sin ( y + 4 \frac{π}{2} ) [ \begin{matrix}( {I}_{x } - {{I}_{t}}_{x} ) cos ( x + 2 \frac{π}{2} ) sin ( y + 4 \frac{π}{2} ) + \\ ( {I}_{y} - {I}_{{t}_{y}} ) cos ( y + 4 \frac{π}{2} ) sin ( x + 2 \frac{π}{2} )\end{matrix} ] + \\ {k}_{x} cos ( x + 5 \frac{π}{2} ) sin ( y + 4 \frac{π}{2} ) [ \begin{matrix}( {I}_{x } - {I}_{{t}_{x}} ) cos ( x + 5 \frac{π}{2} ) sin ( y + 4 \frac{π}{2} ) + \\ ( {I}_{y} - {I}_{{t}_{y}} ) cos ( y + 4 \frac{π}{2} ) sin ( x + 5 \frac{π}{2} )\end{matrix} ] \\ = 2 {I}_{x} {k}_{x} {sin}^{2} ( y ) - 2 {I}_{{t}_{x}} {k}_{x } {sin}^{2} ( y )\end{matrix} & ( 51 )\end{matrix}$$

Once the y-direction offset distances from the center points CEN of coils 306 in each of rows R₁, R₂, R₃, R₄ from the x-direction axis through the center of gravity of the array of coils 306 are established, as shown in FIG. 8 with respect to offset distances L₁-L₄, the total force in the x-direction is found by summing the contributions of the forces generated by each row:

$$\begin{matrix}{F}_{{x}_{total}} = {F}_{x ( row1 )} + {F}_{x ( row2 )} + {F}_{x ( row3 )} + {F}_{x ( row4 )} \\ = 4 {I}_{x} {k}_{a} [ {sin}^{2} ( y ) + {cos}^{2} ( y ) ]\end{matrix} \qquad ( 52 )$$

The total torque is calculated as:

$$\begin{matrix}{T}_{x} = - 4.5 [ 2 {I}_{{t}_{x}} {k}_{a} {cos}^{2 } ( y ) ] - 1.5 [ 2 {I}_{{t}_{x}} {k}_{a} {sin}^{2} ( y ) ] - \\ 1.5 [ 2 {I}_{{t}_{x}} {k}_{a} {cos}^{2} ( y ) ] - 4.5 [ 2 {I}_{{t}_{x}} {k}_{a} {sin}^{2} ( y ) ] \\ = - 12 {I}_{{t}_{x}} {k}_{a} [ {sin}^{2} ( y ) + {cos}^{2} ( y ) ]\end{matrix} \qquad ( 53 )$$

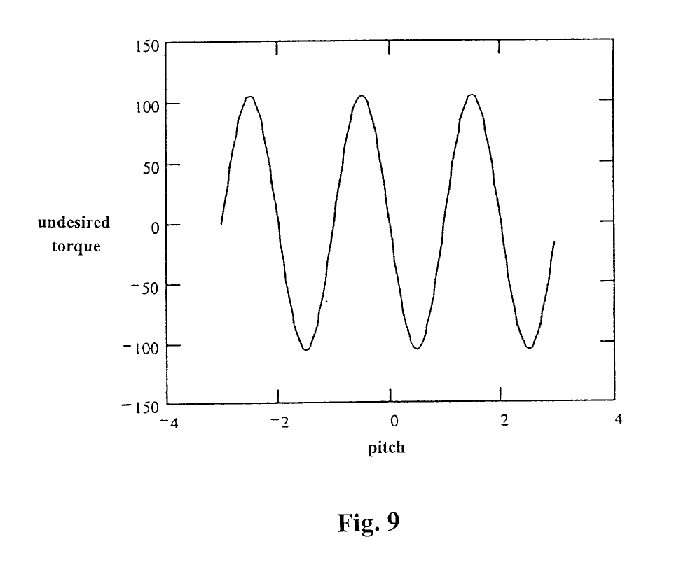

One problem with prior art control schemes is undesired torque in z-rotation due to current applied for x- and y-translation. Such undesirable interaction is frequently referred to as cross-coupling, which creates a ripple behavior. Referring to FIG. 3, if the planar motor generates a translation force in the x-direction along the x-axis (i.e., an offset of 0 pitch in the y-direction), the translation force is generated symmetrically about the center of gravity of the planar motor. This is due to the equidistant spacing of the center of gravity 314 between adjacent rows of magnets 304 parallel to the x-axis. However, if coils 306 are aligned such that the center of gravity is offset in the y-direction from the x-axis (i.e., in an amount of 0.5 pitch), as shown in FIG. 8, the translation force is no longer generated in a symmetrical fashion with respect to the center of gravity 314 and undesired torque occurs. In this instance, the center of gravity 314 is not equidistant from adjacent rows of magnets 304 parallel to the x-axis. To address this problem, torque compensation predicated on the magnitude of the translation force is implemented. The undesired torque generally follows a sinusoidal wave of a sin(x) or cos(x) function, as represented graphically in FIG. 9 showing undesired torque (in Newton-pitch) as a function of pitch (in number of pitch), and calculated as follows:

T_{undesired}=−12kₐIₓ sin(πpt_{y}) (54)

Such behavior would be noticed, for example, if the array of coils 306 is moved from y=−4.5 pitch to y=2.5 pitch.

Undesired torque resulting from x-y translation forces can be canceled using the following compensation function, which is the inverse sign of the equation used to calculate undesired torque:

T_{compensation}=12kₐIₓ sin(πpt_{y}) (55)

where T_{compensation} is the torque desired for compensation. The coil current required for the torque compensation is thus found (using the current term of Eq. 44 and the compensation torque of Eq. 45) as:

$${I}_{{t}_{x ( compensation )}} = \frac{{T}_{compensation}}{12 {k}_{a}} = {I}_{x} sin ( π p {t}_{y} ) \qquad ( 56 )$$

where pt_{y} is the pitch in the y-direction. The torque control current is thus calculated as:

$${I}_{{t}_{x}} = \frac{{T}_{desired}}{12 {k}_{a} + {I}_{{t}_{x ( compensation )}}} \qquad ( 57 )$$

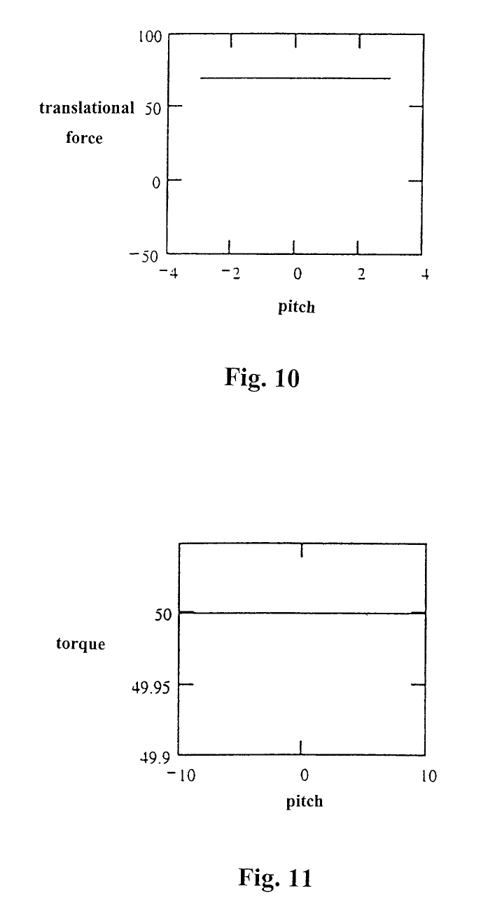

Using the undesired torque compensation function, control is decoupled between the translation force and the torque. Thus, exemplar outputs for the moving coil type planar motor of the present development with no force ripple and no torque ripple are shown in FIGS. 10 and 11, respectively. In particular, as shown in FIG. 10, a plot of translational force (in Newtons) as a function of pitch (in number of pitch), the translation force is at a steady signal target of 70 Newtons. As shown in FIG. 11, a plot of the yaw torque (in Newton-pitch) as a function of pitch (number of pitch), the yaw torque is shown at a signal target of 50 Newton-pitch. The linear behavior demonstrates that the planar motor response meets the target behavior without force ripple.

Advantageously, the moving coil planar motor of the present invention does not require a switch function in order to achieve a desired torque at any given stage location because all of the commutation signal is matched in the sine and cosine math. While the force on a particular magnet in a moving magnet planar motor is not constant, thus necessitating switching in order to match pitch, a very constant force is experienced by the moving coil planar motor and thus no switching is required to match pitch.

Furthermore, only one amplifier is required per coil of the present invention. For example, as shown in equation 50, the commutation current for the coil located at position (R₃, C₁) , which shall be designated hereafter as CC1, is given as:

$$CC1 = [ \begin{matrix}( {I}_{x} - {I}_{{t}_{x}} ) cos ( x - 4 \frac{π}{2} ) sin ( y + 1 \frac{π}{2} ) + \\ ( {I}_{y} - {I}_{{t}_{y}} ) cos ( y + 1 \frac{π}{2} ) sin ( x - 4 \frac{π}{2} )\end{matrix} ] \qquad ( 58 )$$

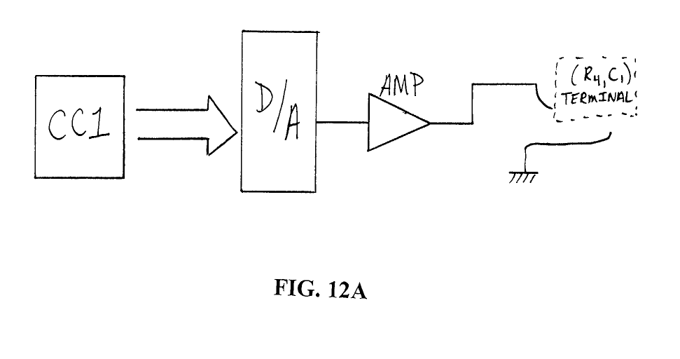

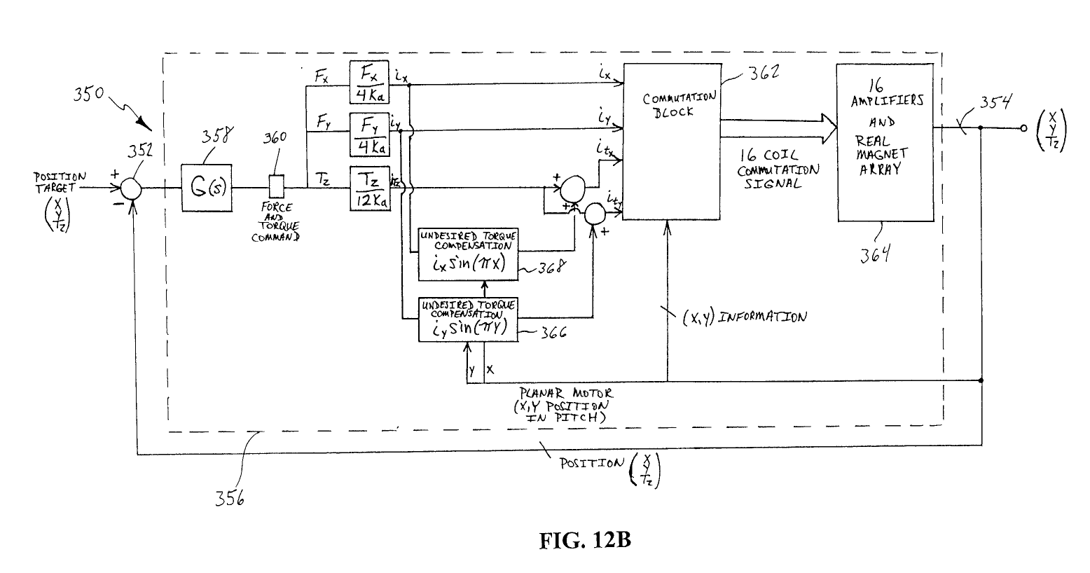

The output of the coil is converted to analog by a digital-to-analog (D/A) converter, and the analog signal is amplified with a power amplifier AMP before reaching the terminal of the coil. Such an arrangement is shown in FIG. 12A. Similarly, the commutation current of each other coil is converted and amplified using one amplifier per coil.

FIG. 12B is a block diagram of a position control system 350 using an exemplary array of sixteen coils 360 according to the present invention. A desired position target is input into a comparator 352. The comparator 352 receives a feedback signal from sensor 354. Controller 356 includes a transfer function 358 in series with a force and torque command module 360. Currents iₓ, i_{y}, for forces Fₓ, F_{y}, respectively, are supplied to commutation block 362, which employs equations 48-51 to create a decoupling force and torque. Similarly, current components iₜₓ and i_{ty} from torque T_{z} are supplied to commutation block 362. The commutation signals from coils 360 are then fed to sixteen amplifiers and the real magnet array 364. Undesired torque compensators 366, 368 receive the position signal for compensation at position 354. As should be appreciated by a person skilled in the art, sensor 354 is generic.

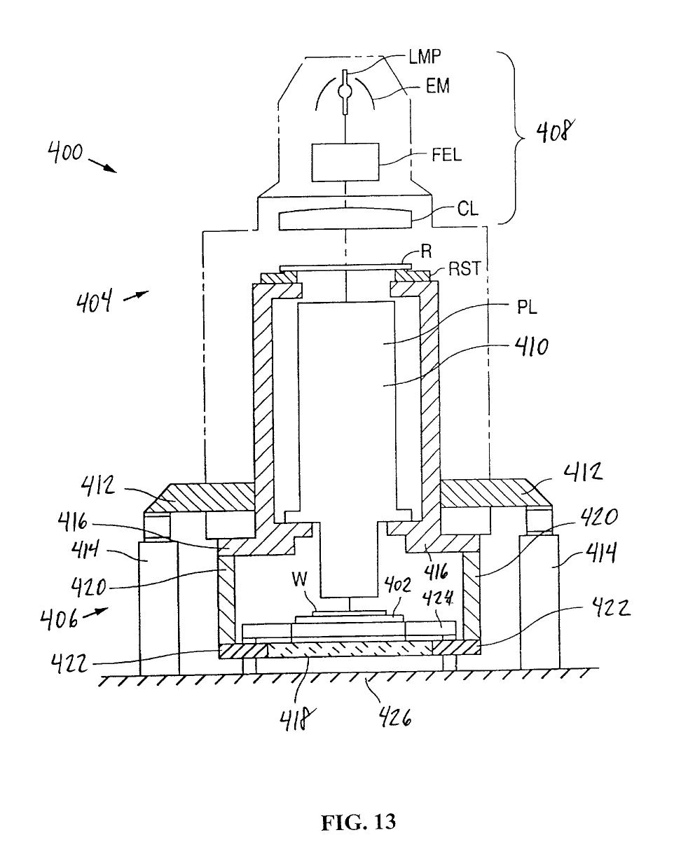

FIG. 13 is an elevational view, partially in section, showing a lithographic apparatus 400 incorporating a planar motor-driven positioning stage 402 in accordance with the present invention. Lithographic apparatus 400, such as described in U.S. Pat. No. 5,528,118 to Lee, which is hereby incorporated by reference in its entirety, includes an upper optical system 404 and a lower wafer support and positioning system 406. Optical system 404 includes an illuminator 408 containing a lamp LMP, such as a mercury vapor lamp, and an ellipsoidal mirror EM surrounding lamp LMP. Illuminator 408 also comprises an optical integrator, such as a fly's eye lens FEL, producing secondary light source images, and a condenser lens CL for illuminating a reticle (mask) R with uniform light flux. A mask holder RST holding mask or reticle R is mounted above a lens barrel PL of a projection optical system. A lens barrel PL is fixed on a part of a column assembly 410 which is supported on a plurality of rigid arms 412, each mounted on the top portion of an isolation pad or block system 414. Lithographic apparatus 400 exposes a pattern of the reticle R onto a wafer W, while mask holder RST and positioning stage 402 are moving synchronously relative to illuminator 408.

Inertial or seismic blocks 416 are located on the system, e.g. mounted on arms 412. Blocks 416 can take the form of a cast box which can be filled with sand at the operation site to reduce the shipping weight of apparatus 400. An object or positioning stage base 418 is supported from arms 412 by depending blocks 416 and depending bars 420 and horizontal bars 422. Positioning stage 402 carrying wafer W is supported in a movable fashion by positioning stage base 418. A reaction frame 424 carries a magnet array (not shown) and drives positioning stage 402 in cooperation with a moving coil array (not shown). Reaction frame 424 is isolated from positioning stage base 418 in terms of vibration relative to a foundation 426, when a force is generated as positioning stage 402 is driven. Positioning stage 402 and/or mask holder RST according to the present invention can be driven by a planar motor such as planar motors 300 described above.

There are a number of different types of photolithographic devices. For example, exposure apparatus 400 can be used as a scanning type photolithography system which exposes the pattern from reticle R onto wafer W with reticle R and wafer W moving synchronously. In a scanning type lithographic device, reticle R is moved perpendicular to an optical axis of lens assembly 404 by reticle stage RST and wafer W is moved perpendicular to an optical axis of lens assembly 404 by wafer stage 402. Scanning of reticle R and wafer W occurs while reticle R and wafer W are moving synchronously.

Alternately, exposure apparatus 400 can be a step-and-repeat type photolithography system that exposes reticle R while reticle R and wafer W are stationary. In the step and repeat process, wafer W is in a constant position relative to reticle R and lens assembly 404 during the exposure of an individual field. Subsequently, between consecutive exposure steps, wafer W is consecutively moved by wafer stage 402 perpendicular to the optical axis of lens assembly 404 so that the next field of semiconductor wafer W is brought into position relative to lens assembly 404 and reticle R for exposure. Following this process, the images on reticle R are sequentially exposed onto the fields of wafer W so that the next field of semiconductor wafer W is brought into position relative to lens assembly 404 and reticle R.

However, the use of exposure apparatus 400 provided herein is not limited to a photolithography system for semiconductor manufacturing. Exposure apparatus 400, for example, can be used as an LCD photolithography system that exposes a liquid crystal display device pattern onto a rectangular glass plate or a photolithography system for manufacturing a thin film magnetic head. Further, the present invention can also be applied to a proximity photolithography system that exposes a mask pattern by closely locating a mask and a substrate without the use of a lens assembly. Additionally, the present invention provided herein can be used in other devices, including other semiconductor processing equipment, machine tools, metal cutting machines, and inspection machines.

The illumination source 408 can be g-line (436 nm), i-line (365 nm), KrF excimer laser (248 nm), ArF excimer laser (193 nm) and F₂ laser (157 nm). Alternatively, illumination source 408 can also use charged particle beams such as x-ray and electron beams. For instance, in the case where an electron beam is used, thermionic emission type lanthanum hexaboride (LaB₆) or tantalum (Ta) can be used as an electron gun. Furthermore, in the case where an electron beam is used, the structure could be such that either a mask is used or a pattern can be directly formed on a substrate without the use of a mask.

With respect to lens assembly 404, when far ultra-violet rays such as the excimer laser are used, glass materials such as quartz and fluorite that transmit far ultra-violet rays are preferably used. When the F₂ type laser or x-ray is used, lens assembly 404 should preferably be either catadioptric or refractive (a reticle should also preferably be a reflective type), and when an electron beam is used, electron optics should preferably comprise electron lenses and deflectors. The optical path for the electron beams should be in a vacuum.

Also, with an exposure device that employs vacuum ultra-violet radiation (VUV of wavelength 200 nm or lower, use of the catadioptric type optical system can be considered. Examples of the catadioptric type of optical system include the disclosure Japan Patent Application Disclosure No. 8-171054 published in the Official Gazette for Laid-Open Patent Applications and its counterpart U.S. Pat. No. 5,668,672, as well as Japan Patent Application Disclosure No. 10-20195 and its counterpart U.S. Pat. No. 5,835,275. In these cases, the reflecting optical device can be a catadioptric optical system incorporating a beam splitter and concave mirror. Japan Patent Application Disclosure No. 8-334695 published in the Official Gazette for Laid-Open Patent Applications and its counterpart U.S. Pat. No. 5,689,377 as well as Japan Patent Application Disclosure No. 10-3039 and its counterpart European Patent Application EP 0816892 A2 also use a reflecting-refracting type of optical system incorporating a concave mirror, etc., but without a beam splitter, and can also be employed with this invention. The disclosures in the above-mentioned U.S. patents, European patent application, as well as the Japan patent applications published in the Official Gazette for Laid-Open Patent Applications are incorporated herein by reference.

Further, in photolithography systems, when linear motors (see U.S. Pat. Nos. 5,623,853 or 5,528,118) are used in a wafer stage or a reticle stage, the linear motors can be either an air levitation type employing air bearings or a magnetic levitation type using Lorentz force or reactance force. Additionally, the stage could move along a guide, or it could be a guideless type stage which uses no guide. The disclosures in U.S. Pat. Nos. 5,623,853 and 5,528,118 are incorporated herein by reference.

Alternatively, one of the stages could be driven by a planar motor, which drives the stage by electromagnetic force generated by a magnet unit having two-dimensionally arranged magnets and an armature coil unit having two-dimensionally arranged coils in facing positions. With this type of driving system, either one of the magnet unit or the armature coil unit is connected to the stage and the other unit is mounted on the moving plane side of the stage.

Movement of the stages as described above generates reaction forces which can affect performance of the photolithography system. Reaction forces generated by the wafer (substrate) stage motion can be mechanically released to the floor (ground) by use of a frame member as described in U.S. Pat. No. 5,528,118 and published Japanese Patent Application Disclosure No. 8-166475. Additionally, reaction forces generated by the reticle (mask) stage motion can be mechanically released to the floor (ground) by use of a frame member as described in U.S. Pat. No. 5,874,820 and published Japanese Patent Application Disclosure No. 8-330224. The disclosures in U.S. Pat. Nos. 5,528,118 and 5,874,820 and Japanese Patent Application Disclosure No. 8-330224 are incorporated herein by reference.

As described above, a photolithography system according to the above-described embodiments can be built by assembling various subsystems, including each element listed in the appended claims, in such a manner that prescribed mechanical accuracy, electrical accuracy and optical accuracy are maintained. In order to maintain the various accuracies, prior to and following assembly, every optical system is adjusted to achieve its optical accuracy. Similarly, every mechanical system and every electrical system are adjusted to achieve their respective mechanical and electrical accuracies. The process of assembling each subsystem into a photolithography system includes mechanical interfaces, electrical circuit wiring connections and air pressure plumbing connections between each subsystem. Needless to say, there is also a process where each subsystem is assembled prior to assembling a photolithography system from the various subsystems. Once a photolithography system is assembled using the various subsystems, total adjustment is performed to make sure that every accuracy is maintained in the complete photolithography system. Additionally, it is desirable to manufacture an exposure system in a clean room where the temperature and humidity are controlled.

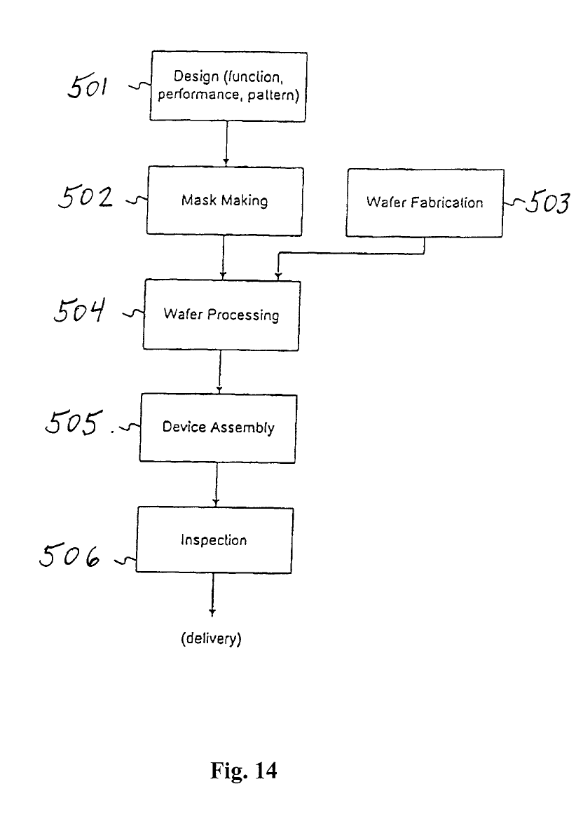

Further, semiconductor devices can be fabricated using the above-described systems, by the process shown generally in FIG. 14. In step 501 the device's function and performance characteristics are designed. Next, in step 502, a mask (reticle) having a pattern is designed according to the previous designing step, and in a parallel step 503, a wafer is made from a silicon material. The mask pattern designed in step 502 is exposed onto the wafer from step 503 in step 504 by a photolithography system described hereinabove consistent with the principles of the present invention. In step 505 the semiconductor device is assembled (including the dicing process, bonding process and packaging process), and then finally the device is inspected in step 506.

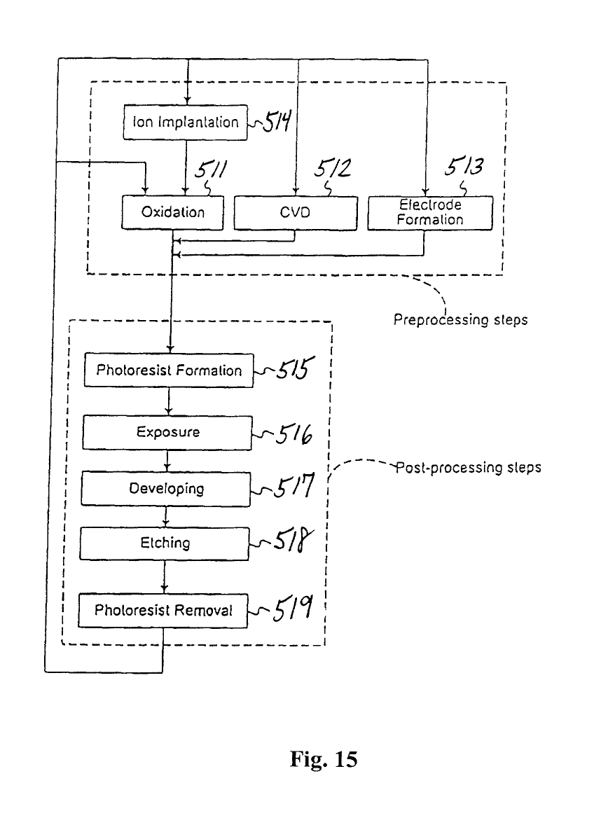

FIG. 15 illustrates a detailed flowchart example of the above-mentioned step 504 in the case of fabricating semiconductor devices. In step 511 (oxidation step), the wafer surface is oxidized. In step 512 (CVD step), an insulation film is formed on the wafer surface. In step 513 (electrode formation step), electrodes are formed on the wafer by vapor deposition. In step 514 (ion implantation step), ions are implanted in the wafer. The above-mentioned steps 511-514 form the preprocessing steps for wafers during wafer processing, and selection is made at each step according to processing requirements.

At each stage of wafer processing, when the above-mentioned preprocessing steps have been completed, the following post-processing steps are implemented. During post-processing, initially, in step 515 (photoresist formation step), photoresist is applied to a wafer. Next, in step 516 (exposure step), the above-mentioned exposure device is used to transfer the circuit pattern of a mask (reticle) to a wafer. Then, in step 517 (developing step), the exposed wafer is developed, and in step 518 (etching step), parts other than residual photoresist (exposed material surface) are removed by etching. In step 519 (photoresist removal step), unnecessary photoresist remaining after etching is removed.

Multiple circuit patterns are formed by repetition of these preprocessing and post-processing steps.

It will be apparent to those skilled In the art that various modifications and variations can be made in the methods described, in the stage device, the control system, the material chosen for the present invention, and in construction of the photolithography systems as well as other aspects of the invention without departing from the scope or spirit of the invention.

While various descriptions of the present invention are described above, it should be understood that the various features can be used singly or in any combination thereof. Therefore, this invention is not to be limited to only the specifically preferred embodiments depicted herein.

Further, it should be understood that variations and modifications within the spirit and scope of the invention may occur to those skilled in the art to which the invention pertains. For example, magnet arrays and coil arrays having a different number of magnets and/or coils, respectively, from those discussed in detail herein may be used in accordance with the principles of the present invention. In one exemplary embodiment, with a stage stroke requirement of 10 pitch, the magnet area is selected to be at least two pitch greater than the stage stroke on each side of the stage. Accordingly, all expedient modifications readily attainable by one versed in the art from the disclosure set forth herein that are within the scope and spirit of the present invention are to be included as further embodiments of the present invention. The scope of the present invention is accordingly defined as set forth in the appended claims.

What is claimed is:

1. A planar motor comprising:
a magnet array having a plurality of magnets;
a coil array having a plurality of coils;
a control system configured to selectively provide electric current to the coil array for translational movement in two degrees of freedom and rotation in a third degree of freedom, said current being controlled to at least substantially reduce force and torque ripple in said movement.

2. The planar motor of claim 1, wherein the coil array is square.

3. The planar motor of claim 2, wherein the coil array comprises sixteen coils.

4. The planar motor of claim 2, wherein the control system comprises one amplifier for each coil.

5. The planar motor of claim 1, wherein the magnet array is disposed about a magnet plane and the translational movement occurs in directions substantially parallel to the magnet plane.

6. The planar motor of claim 5, where the directions are substantially orthogonal to one another.

7. The planar motor of claim 6, wherein the directions are the x-direction and y-direction, a plurality of coils disposed parallel to the x-direction define a row and a plurality of coils disposed parallel to the y-direction define a column, the coils in each row and each column producing a torque that follows the relationship 12Iₜkₐ, where Iₜ is the current and is the magnetic force constant of a coil.

8. The planar motor of claim 6, wherein the directions are the x-direction and y-direction, current supplied to the coil array for translational movement follows the relationship
$$\frac{F}{4 {k}_{a}} ,$$
and wherein Fₙ is the component of force in the x-direction or the y-direction and kₐ is the magnetic force constant of a coil.

9. The planar motor of claim 6, wherein the directions are the x-direction and y-direction, current supplied to the coil array for torque follows the relationship
$$\frac{{Torque}_{n}}{12 {k}_{a}} ,$$
and wherein Torqueₙ is the component of torque from one or more coils in a x-direction or a y-direction and kₐ is the magnetic force constant of a coil.

10. The planar motor of claim 1, wherein the control system compensates for undesired torque.

11. The planar motor of claim 10, wherein the undesired torque is a sinusoidal function.

12. The planar motor of claim 11, wherein the sinusoidal function is compensated by a negative of the sinusoidal function.

13. The planar motor of claim 1, wherein current applied to the coil array produces a force for the translational movement that is a function of the product of the current and a force constant.

14. The planar motor of claim 1, wherein current applied to the coil array produces a torque that is a function of the product of the current and a force constant.

15. A lithographic instrument comprising:
a positioning stage;
a planar magnet array;
a planar coil array coupled to the positioning stage;
a control system configured to selectively provide electric current to the coil array for translational movement in two degrees of freedom and rotation in a third degree of freedom, said current being controlled to at least substantially reduce force and torque ripple in said movement.

16. A method for controlling a planar motor for positioning in three degrees of freedom, the method comprising:
positioning a movable coil array over a fixed magnet array, the coil array having coils generally disposed in a plane defining first and second directions that are substantially orthogonal to one another, and the magnet array having magnets with magnetic fields;
determining currents to be applied to coils to generate substantially ripple free translational forces between the coil array and the magnet array in the first and second directions and substantially ripple free torque about a third direction perpendicular to the plane;
applying currents as determined to the coils to move the coils.

17. The method of claim 16, wherein the determining currents comprises determining compensating currents required to compensate for undesired force and torque.

18. The method of claim 17, wherein the undesired torque is a sinusoidal function and the compensating currents are the negative of the sinusoidal function.

19. The method of claim 18, wherein the undesired torque follows the relationship −12kₐIₓ sin(πpt_{y}), wherein kₐ is the magnetic force constant of a coil, Iₓ is the current, and pt_{y} is the pitch.

20. A system for controlling a planar motor, said motor including an array of coils for producing translational forces in two degrees of freedom, said system comprising:
a controller;
a sensor for sensing position of the coils;
a first comparator for receiving position feedback from the sensor; and
a second comparator for receiving input from a position disturbance in a third degree of freedom,
wherein said controller at least substantially applies a compensation function to said position disturbance and provides a corrected output position.

21. The processor of claim 20, wherein the controller comprises at least two amplifiers.

22. A planar motor comprising:
magnet array means;
coil array means; and
control means providing electric current to said coil array means for controlled movement in three degrees of freedom including means for at least substantially eliminating ripple.

23. A stage system comprising:
a planar motor, said planar motor comprising a magnet array having a plurality of magnets, a coil array having a plurality of coils, and a control system configured to selectively provide electric current to the coil array for translational movement in two degrees of freedom and rotation in a third degree of freedom, said current being controlled to at least substantially reduce force and torque ripple in said movement.

24. An exposure apparatus comprising:
an illumination system that supplies radiant energy; and
a stage system comprising a planar motor, said planar motor comprising a magnet array having a plurality of magnets, a coil array having a plurality of coils, and a control system configured to selectively provide electric current to the coil array for translational movement in two degrees of freedom and rotation in a third degree of freedom, said current being controlled to at least substantially reduce force and torque ripple in said movement,
wherein said stage system carries at least one object disposed on a path of said radiant energy.

25. A device manufactured with the exposure apparatus of claim 24.

26. A wafer comprising an image, wherein said image is formed with an exposure apparatus comprising:
an illumination system that supplies radiant energy; and
a stage system comprising a planar motor, said planar motor comprising a magnet array having a plurality of magnets, a coil array having a plurality of coils, and a control system configured to selectively provide electric current to the coil array for translational movement in two degrees of freedom and rotation in a third degree of freedom, said current being controlled to at least substantially reduce force and torque ripple in said movement,
wherein said stage system carries at least one object disposed on a path of said radiant energy.
